(19) United States
(12) Patent Application Publication
(10) Pub. No.: US 2016/0174531 A1
(43) Pub. Date: Jun. 23, 2016

(54) Aquaculture Pump System and Method

(71) Applicant: Pentair Water Pool and Spa, Inc., Sanford, NC (US)

(72) Inventors: Brian J. Boothe, Raleigh, NC (US); Thomas Losordo, Raleigh, NC (US); Robert W. Stiles, JR., Cary, NC (US)

(21) Appl. No.: 14/575,571

(22) Filed: Dec. 18, 2014

(51) Int. Cl. A01K 63/04; F04D 15/00; F04D 13/08; C02F 3/02; A01K 63/00

(52) U.S. Cl. CPC A01K 63/047; C02F 3/02; A01K 63/006; A01K 63/045; F04D 13/08; F04D 15/0066

(57) ABSTRACT

Embodiments of the invention provide a constant flow variable speed pump for use in a recirculating aquaculture application. The pump includes a housing with an inlet and an outlet, an impeller positioned within the housing, and a motor coupled to the impeller and configured to rotate the impeller within the housing, causing water flow through the recirculating aquaculture application. The pump also includes a controller in communication with the motor and configured to drive the motor. The controller is configured to adjust a speed of the motor to maintain a first flow rate through the recirculating aquaculture application between a first start time and a first stop time according to a first user-defined schedule, and to maintain a second flow rate through the recirculating aquaculture application between a second start time and a second stop time according to a second user-defined schedule.

### BACKGROUND

Pumps may be used to recirculate water in aquatic farms, such as recirculating aquaculture systems in which fish and other aquatic life are raised. Recirculating aquaculture systems generally include one or more culture tanks to contain the fish, one or more water inlets into the tank(s), and one or more water outlets out of the tank(s). The water outlets are typically in communication with an inlet of a pump that propels water through a filter and back into the tank through the water inlets.

Conventional recirculating aquaculture systems usually have a sizable upfront cost to design and build, and also have high operating costs that make it difficult for recirculating aquaculture farmers to compete with other types of aquaculture farms, such as ponds and net pen operations. For example, conventional recirculating aquaculture systems usually provide manually adjusted water flow through the culture tank, depending upon the size or requirements of the aquatic life. Additionally, aquaculture farmers must monitor such systems for proper water flow in order to maintain safe levels of, for example, dissolved oxygen, carbon dioxide, ammonia, and nitrite within the culture tank and, also, to remove solid waste. Suboptimal water conditions, due to improper water flow rates, can result in reduced growth rates or even death of the aquatic life.

Generally, aquaculture farmers continuously operate a single-speed pump or pumps within the system, and may manually adjust valves throughout the system to alter water flow rates. Adjustments must be made during different times of day (e.g., feeding time, resting time, etc.), during different phases of the aquatic life's growth cycles, and/or as the aquaculture system conditions change (e.g., due to pressure build-up from, for example, dirty filters in the system). This can be very tedious for experienced aquaculture farmers and makes for a steep learning curve in start-up aquaculture systems. In many instances, farmers view this process as time consuming and continuously operate one or more pumps at a high speed to accommodate the flow needs for the feeding times. Further, due to the continuous pump operation at a maximum speed, electricity is a significant operating cost for recirculating aquaculture farms.

In light of the above issues, a need exists for a way in which to lower the operating cost and improve performance of recirculating aquaculture systems.

### SUMMARY

Some embodiments of the invention provide a recirculating aquaculture system for housing aquatic life. The system includes a culture tank, a fluid circuit including the culture tank, a drain line exiting the culture tank, and a return line entering the culture tank, and at least one of a biofilter, an oxygen cone, a regenerative air blower, a degassing column in communication with the fluid circuit. The system also includes a variable speed pump in communication with the fluid circuit and configured to pump water through the fluid circuit into and out of the culture tank. The variable speed pump includes a motor and a controller configured to operate the motor to maintain a constant flow rate through the fluid circuit despite pressure and water condition changes within the fluid circuit.

Some embodiments of the invention provide a constant flow variable speed pump for use in a recirculating aquaculture application. The pump includes a housing with an inlet and an outlet, and a motor configured to cause water flow through the recirculating aquaculture application. The pump also includes a controller in communication with the motor and configured to drive the motor. The controller is configured to adjust a speed of the motor to maintain a first flow rate through the recirculating aquaculture application between a first start time and a first stop time according to a first user-defined schedule, and to maintain a second flow rate through the recirculating aquaculture application between a second start time and a second stop time according to a second user-defined schedule.

Some embodiments of the invention provide a method of operating a variable speed pump in an aquaculture system. The method includes obtaining at least one of a current speed parameter or a power consumption parameter of the aquaculture system, determining a reference parameter based on a user-defined flow rate through the aquaculture system, and calculating a difference value between the at least one of a current speed parameter or a power consumption parameter obtained and the reference parameter. The method also includes updating a pump motor speed based on the difference value and driving a motor of the variable speed pump at the updated pump motor speed to maintain the user-defined flow rate.

### DESCRIPTION OF THE DRAWINGS

FIG. 1 is a schematic view of an aquaculture system according to one embodiment;

FIG. 2 is an isometric view of a constant flow variable speed pump, according to one embodiment, for use with the aquaculture system of FIG. 1;

FIG. 3 is an exploded isometric view of the constant flow variable speed pump of FIG. 3;

FIG. 4 is a schematic view of electrical connections to a controller of the variable speed pump of FIG. 3, according to one embodiment;

FIG. 5 is a front elevational view of a user interface of a controller for use with the constant flow variable speed pump of FIG. 3;

FIG. 6 is an isometric view of an external controller for use with the constant flow variable speed pump of FIG. 3;

FIG. 6A is an isometric view of a user interface of the external controller of FIG. 6;

FIGS. 7A-7B illustrate a flow chart of menu settings of the controller of FIG. 5, according to one embodiment;

FIG. 8 is a schematic representation of a command path of the controller of FIG. 5, according to one embodiment; and

FIG. 9 is a flow chart illustrating method for delivering a constant flow rate in a recirculating aquaculture system.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Embodiments of the present disclosure provide systems and methods for operating a constant flow pump system in an aquaculture application. Aquaculture applications can include commercial aquaculture systems, laboratory animal housing systems, aquatic life support systems, aquaponics systems, water quality management systems, and lake and pond management systems, among others. Each aquaculture application can include components and methods to support aquatic life, including a constant flow pump system with one or more of a culture tank, a method of removing solid waste, a method of nitrification, and a method of gas exchange.

Each application has specific water flow requirements to ensure continuous and substantial growth of the housed aquatic life, and such requirements change during the life cycle of the aquatic life. Further, water flow conditions change due to pressure build-up in application components and/or other changes to the water flow path or circuit, for example. The constant flow pump system of the present invention operates to maintain a constant, user-defined flow through the circuit, and self-adjusts to maintain that flow even as system conditions change, to sustain an optimal environment for aquatic life, and optimize energy usage of application.

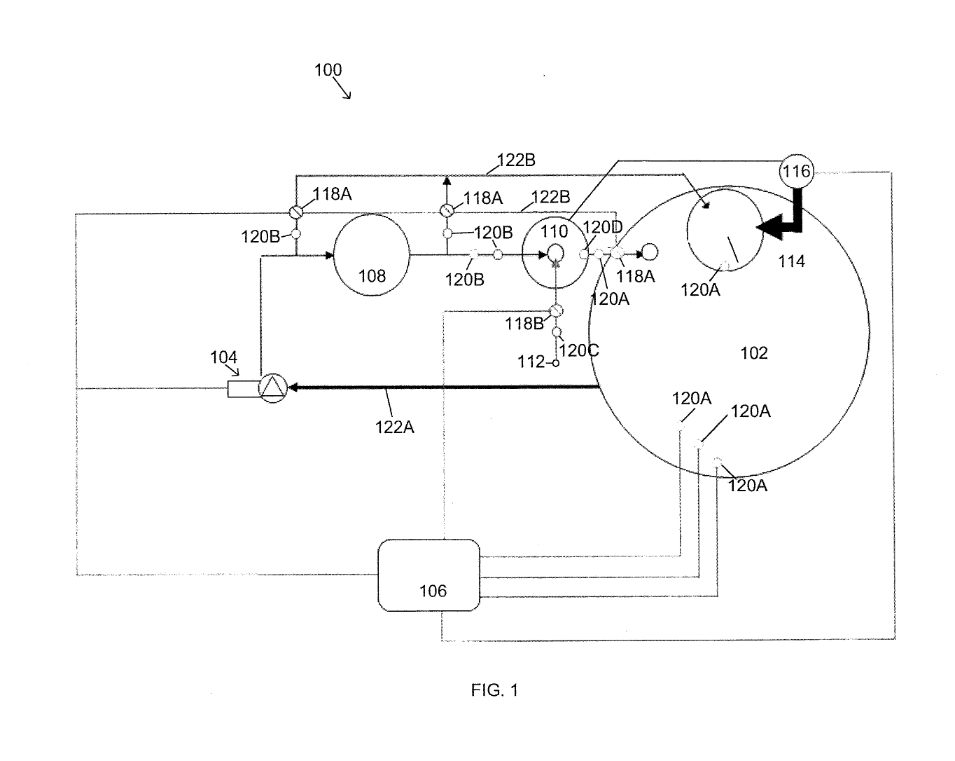

For example, FIG. 1 illustrates an aquaculture system 100 according to one embodiment. The aquaculture system 100 may include one or more culture tanks 102 capable of housing aquatic life, a variable speed pump 104, a controller 106, a biofilter 108, an oxygen cone 110, an oxygen gas inlet 112, a degasser 114, an air blower 116, a plurality of control valves 118, and a plurality of sensors 120. The variable speed pump 104 can be in communication (such as electrical communication or fluid communication) with one or more of the above components. Further, the variable speed pump 104 can circulate water through one or more of the above components, e.g., via piping or plumbing connections 122, creating a fluid circuit.

The culture tank 102 is designed to support and hold aquatic life. One or more culture tanks 102 may be provided in parallel and/or in series, or otherwise be in communication with each other to form the aquaculture system 100. The variable speed pump 104 can pump water into and out of the culture tank 102, through the fluid circuit, thus providing proper circulation and water treatment to ensure optimal conditions for the aquatic life within the culture tank 102. The aquaculture system 100 may include other structures or setups to support aquatic life, including, for example, a pond or other area of confinement.

Regarding water treatment, the biofilter 108 can be in fluid communication with the culture tank 102 and the variable speed pump 104 and can treat water within the fluid circuit. More specifically, biological filtration and nitrification may be accomplished by the biofilter 108 (e.g., a fluidized bed filter, a mixed bed filter, a trickling filter, a rotating biocontactor, a membrane bioreactor, etc.). Also, the biofilter 108 is in fluid communication with the oxygen cone 110. The oxygen cone 110, and/or oxygen saturators, may efficiently optimize gas transfer (e.g., of oxygen or ozone) in the water of the culture tank 102. For example, the oxygen cone 110 uses the change in water velocity that occurs in different diameter pipes to ensure complete or substantially complete diffusion of pure oxygen bubbles into the water. The oxygen cone 110 further functions to increase gas pressure in order to diffuse oxygen more rapidly into the water.

The aquaculture system 100 may further include the regenerative air blower (e.g., the air blower 116) that is in fluid communication with the oxygen cone 110. Diffuser-based aeration increases gas exchange by providing increased surface area of the gas/water interface at the bubble surface. Diffuser-based aeration also stirs the water, which thins the stagnant boundary layer at the bubbles and the top of the water in the culture tank 102. The air blower 116 is designed to provide large volumes of air (e.g., from about 0.37 m³/min to about 36.1 m³/min) at low pressures (less than about 27.58 KPa) and is commonly used in conjunction with one or more of air diffusers and/or air lifts. The combination of the air blower 116 with one or more air diffusers adds oxygen and removes carbon dioxide with relatively low power consumption. The air blower 116 may also deliver oil-free air, for example, to water in the biofilter 108.

The air blower 116 is further in fluid communication with a degassing column (e.g., the degasser 114). The degasser 114 is used for removing nitrogen, hydrogen sulfide, carbon dioxide, other gases, and/or a combination thereof from water. The degasser 114 may also add oxygen to undersaturated water. In the recirculating aquaculture system 100, where oxygen is used, carbon dioxide levels may rise to narcotic or toxic levels. The degasser 114 may serve two roles, depending upon the quality of incoming water. For example, if water is supersaturated with dissolved gases, the degasser 114 may substantially relieve the supersaturated condition. Additionally, for instances where the dissolved oxygen level of the water is low, the degasser 114 may substantially saturate the water with dissolved oxygen.

The aquaculture system 100 includes the plurality of valves 118, which can be used to regulate the flow and/or pressure of water and/or gas within the culture tank 102 and/or within other parts of the aquaculture system 100. The plurality of valves 118 may include, but are not limited to, water proportional control valves 118A (as shown in FIG. 1), oxygen gas proportional control valves 118B, and other control valves that are designed to regulate the flow and/or pressure of water and/or gas or air associated with water quality, and combinations thereof. For example, each of the plurality of valves 118 may include actuators and/or positioners to open and close the valves in order to regulate the flow and/or pressure therethrough.

The aquaculture system 100 also may include the plurality of sensors 120. The plurality of sensors 120 are used to detect concentrations of at least one of oxygen, nitrite, ammonia, carbon dioxide, other analytes, and the like, and combinations thereof, within the water of, or related to, the culture tank 102. The plurality of sensors 120 may be positioned throughout the system and are in communication with the controllers 106 and/or 128 (described below) for monitoring one or more parameters of the system 100. Parameters of the system 100 may include, but are not limited to, dissolved oxygen, nitrite, ammonia, carbon dioxide, water flow rate, oxygen gas flow rate, oxygen gas pressure, water pressure sensors, suspended solids, undissolved oxygen, nitrate, temperature, pH, salinity, conductivity, oxidation-reduction potential (ORP), turbidity, atmospheric pressure, water level, saturation, alkalinity, and other water quality parameters known in the art. Some parameters, such as dissolved oxygen, carbon dioxide, ammonia, temperature, may be measured directly from the sensors 120 (e.g., digital probes or potentiometers). Other parameters, such as alkalinity, saturation, etc. may be measured or calculated indirectly by the controllers 106 and/or 128 (e.g., through equations and/or stored lookup tables) using outputs from the sensors 120 (e.g., optical sensors, ultrasonic sensors, infrared sensors, etc.). In some embodiments, the plurality of sensors 120 may include, but are not limited to, water quality probes 120A, water flow rate sensors 120B, oxygen gas flow rate and pressure sensors 120C, water pressure sensors 120D, and other sensors that are designed to detect one or more analytes or parameters associated with water quality, and combinations thereof

As discussed above, the culture tank 102 is in fluid communication with the variable speed pump 104. The variable speed pump 104 provides circulation of water within the culture tank 102 by removing slower water from the bottom of the tank 102, where carbon dioxide is rich, via a drain line 122A. One or more return lines 122B from the variable speed pump 104 then directs the return flow of water (e.g., treated water) back to the culture tank 102 and/or through additional components of the aquaculture system 100. The variable speed pump 104 may have any suitable construction and/or configuration for providing the desired force to move the water. For example, in one embodiment, the variable speed pump 104 is a common centrifugal pump of the type known to have impellers extending radially from a central axis. Vanes defined by the impellers create interior passages through which the water passes as the impellers are rotated. Rotating the impellers about the central axis imparts a centrifugal force on water therein, and thus imparts the force flow to the water.

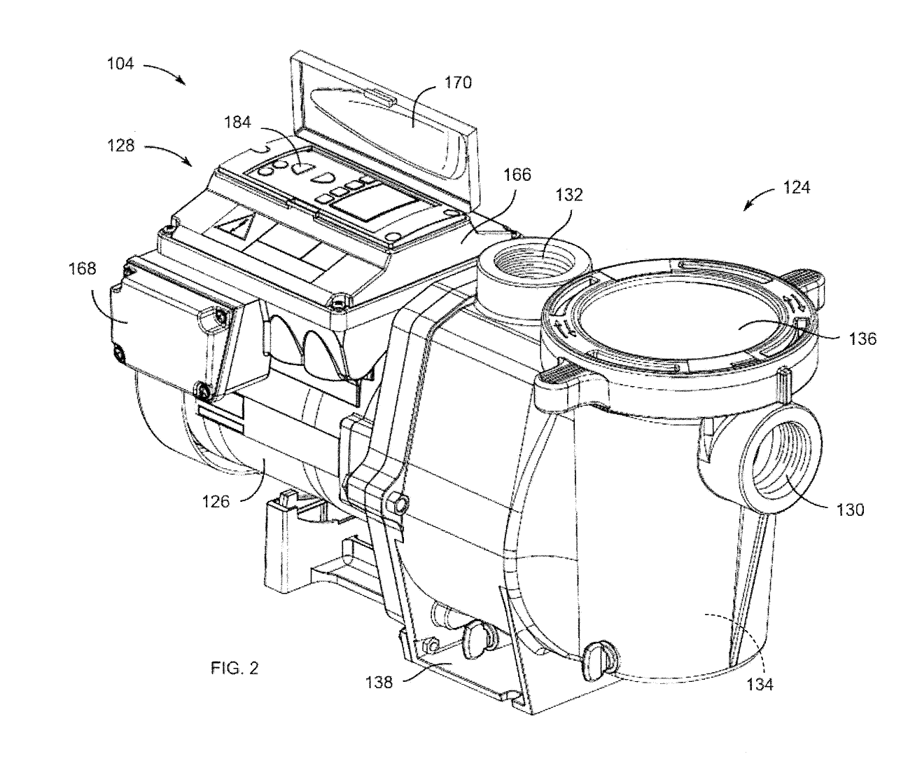

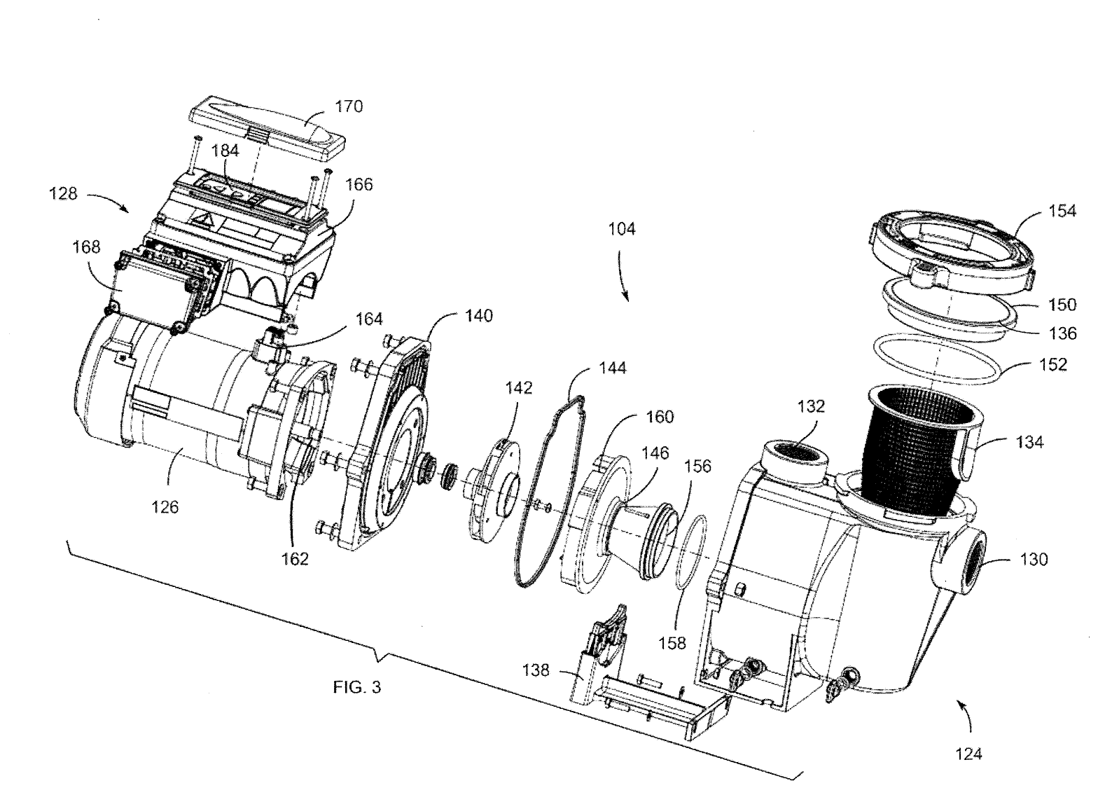

FIGS. 2 and 3 illustrate the variable speed pump 104 according to one embodiment. The variable speed pump 104 may include a housing 124, a motor 126, and a controller 128 (which may include a variable frequency drive controller). The housing 124, the motor 126, and the controller 128 may collectively be considered a pumping system. The housing 124 may include an inlet 130 for receiving water, an outlet 132 for expelling water, a basket 134, a lid 136, and a stand 138. The stand 138 may support the motor 126 and may be used to mount the variable speed pump 104 on a suitable surface (not shown). In some embodiments, the inlet 130 and outlet 132 may be sized as two-inch NPT (national pipe thread) ports. In one embodiment, the approximate dimensions of the variable speed pump 104 can be about 60 cm (length) by about 28 cm (width) by about 32 cm (height). Further, in one embodiment, the variable speed pump 104 can be UL 778 listed.

FIG. 3 depicts the internal components of the variable speed pump 104 according to one embodiment. As shown in FIG. 3, the variable speed pump 104 may include a seal plate 140, an impeller 142, a gasket 144, a diffuser 146, and the basket 134. In some embodiments, the lid 136 may include a cap 150, an O-ring 152, and a clamp 154. The cap 150 and the O-ring 152 may be coupled to the basket 134 by attaching the clamp 154 to an upper portion of the housing 124. The clamp 154 may be joined to the housing 124 via a threaded connection, am interference fit, or any other joining mechanism. The O-ring 152 may seal the connection between the basket 134 and the lid 136. An inlet 156 of the diffuser 146 may be fluidly sealed to the basket 134 with a seal 158. In some embodiments, the diffuser 146 may enclose the impeller 142. An outlet 160 of the diffuser 146 may be fluidly sealed to the seal plate 140 and the seal plate 140 may be sealed to the housing 124 with the gasket 144. In some embodiments, the above-described seals and gaskets (and/or any others in the variable speed pump 104) can be heavy-duty seals and one or more internal fasteners of the variable speed pump 104 can be saltwater-rated stainless steel fasteners to ensure robust service life in harsh conditions of the aquaculture system 100.

Still referring to FIG. 3, drive force is provided to the variable speed pump 104 via the variable speed pump motor 126. More specifically, the motor 126 may include a shaft 162, which may be coupled to the impeller 142. The motor 126 may rotate the impeller 142, drawing fluid from the inlet 130 through the basket 134 and the diffuser 146 to the outlet 132. Thus, the drive force is provided in the form of rotational force provided to rotate the impeller 142 of the variable speed pump 104.

In one specific embodiment, the variable speed pump motor 126 is a permanent magnet synchronous motor that is totally enclosed and fan-cooled. The variable speed pump motor 126 may also be a single-phase motor or a six-pole, three-phase motor. The variable speed pump motor 126 operation is infinitely variable within a range of operation (i.e., zero to maximum operation, or maximum speed). In one specific example, the operation is indicated by the RPM of the rotational force provided to rotate the impeller 142 of the variable speed pump 104. In some embodiments, the motor may range from about ½ horsepower (hp) to about 11 hp, or more than about 11 hp. In one embodiment, the motor 126 may be a 3 hp, single-phase motor, rated for 240 volts, alternating current (±10%), 3200 watts, 16 full load amps (FLA), 1.32 service factor (SF), and 3.95 service factor horse power (SFHP). The motor 126 may operate on 50-Hertz or 60-Hertz input power. In one embodiment, the motor 126 may be driven at four, eight, or more different speeds. The variable speed pump motor 126 and, more particularly, the variable frequency drive controller 128, can operate at high efficiency (e.g., about 92% efficiency at 3450 RPM and about 90% efficiency at 1100 RPM) and, as a result, the variable speed pump motor 126 can operate at lower temperatures compared to other, lower efficiency pump motors. Also, the controller 128 can maintain a minimum power factor of about 0.95.

As shown in FIG. 3, the motor 126 may include a coupling 164 used to connect to the controller 128. The controller 128 may be associated with the variable speed pump 104, or may be provided separately (e.g., the controller 106). Generally, the controllers 106 and/or 128 may adjust the speed of the variable speed pump 104 to maintain a constant, desired flow through the aquaculture system 100. Further, each of the controllers 106, 128 discussed herein may be designed to control one or more operations and/or parameters of the aquaculture system 100, alone, or in conjunction with each other. In some embodiments, the controller 128 is configured within the aquaculture system 100 to operate simultaneously or in conjunction with another controller 106. In other embodiments, the controllers 106 and 128 are configured within the aquaculture system 100 to operate independently. In yet other embodiments, at least one of the controllers 106, 128 may be configured as an operating component of the aquaculture system 100. In addition, in some embodiments, the controllers 106 and/or 128 may be in two-way communication with each other, the biofilter 108, one or more of the sensors 120, and/or one or more of the control valves 118. Two-way communication in the aquaculture system 100 may be performed as disclosed in U.S. Pat. No. 7,854,597 entitled “Pumping System with Two-Way Communication” and issued on Dec. 21, 2010, the entire contents of which is herein incorporated by reference in its entirety.

The controller 128 may be enclosed in a case 166 (as shown in FIGS. 2 and 3). The case 166 may include a field-wiring compartment 168 and a cover 170. The cover 170 may be opened and closed to allow access to the controller 128 and protect the controller 128 from moisture, dust, and other environmental influences. The case 166 may be mounted on the motor 126 and/or another portion of the pump 104. In some embodiments, the field wiring compartment 168 and/or another portion of the pump 104, and may include a power supply (not shown) to provide power to the motor 126 and the controller 128. In one embodiment, the case 166 can be a NEMA IP55 rated enclosure to permit robust service in wet locations and harsh conditions.

The controllers 106 and/or 128 may comprise a processor and memory interconnected with the processor via a communication link. In some embodiments, microcode, instructions, databases, and/or combinations thereof are encoded in the memory. In certain embodiments, the memory comprises non-volatile memory. In some embodiments, the memory comprises battery backed up RAM, a magnetic hard disk assembly, an optical disk assembly, an electronic memory, or combinations thereof. The term “electronic memory” can include PROM, EPROM, EEPROM, SMARTMEDIA, FLASHMEDIA, and the like, and combinations thereof.

The processor may use the microcode to operate the controllers 106 and/or 128 (independently or in tandem). The processor may use microcode, instructions, databases, and combinations thereof to operate the variable speed pump 104, the biofilter 108, the oxygen cone 110, the oxygen gas inlet 112, the degasser 114, the air blower 116, the plurality of control valves 118, the plurality of sensors 120, or combinations thereof. For example, as described above, the controller 128 may include a variable frequency drive controller. As a result, the processor can operate the variable speed pump 104 by controlling the frequency of the current output to the motor 126, as well as the voltage output to the motor 126, in order to control motor rotational speed and, thus, water flow rate through the variable speed pump 104.

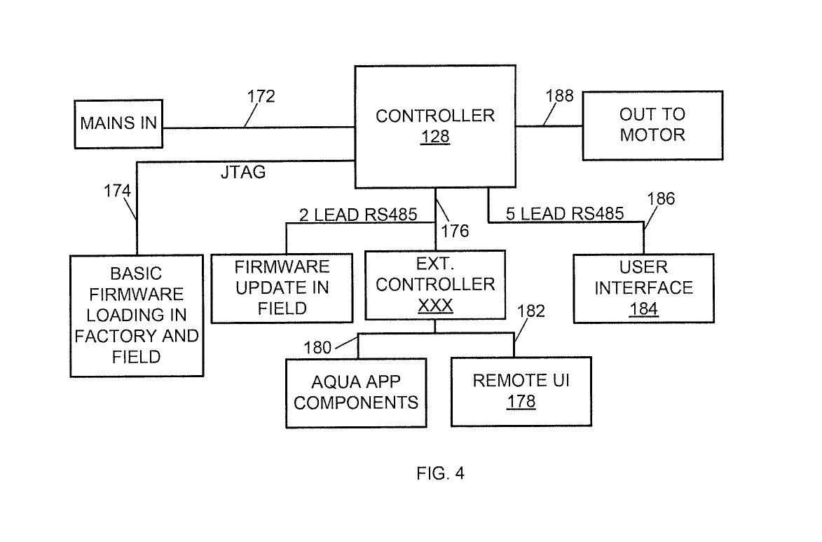

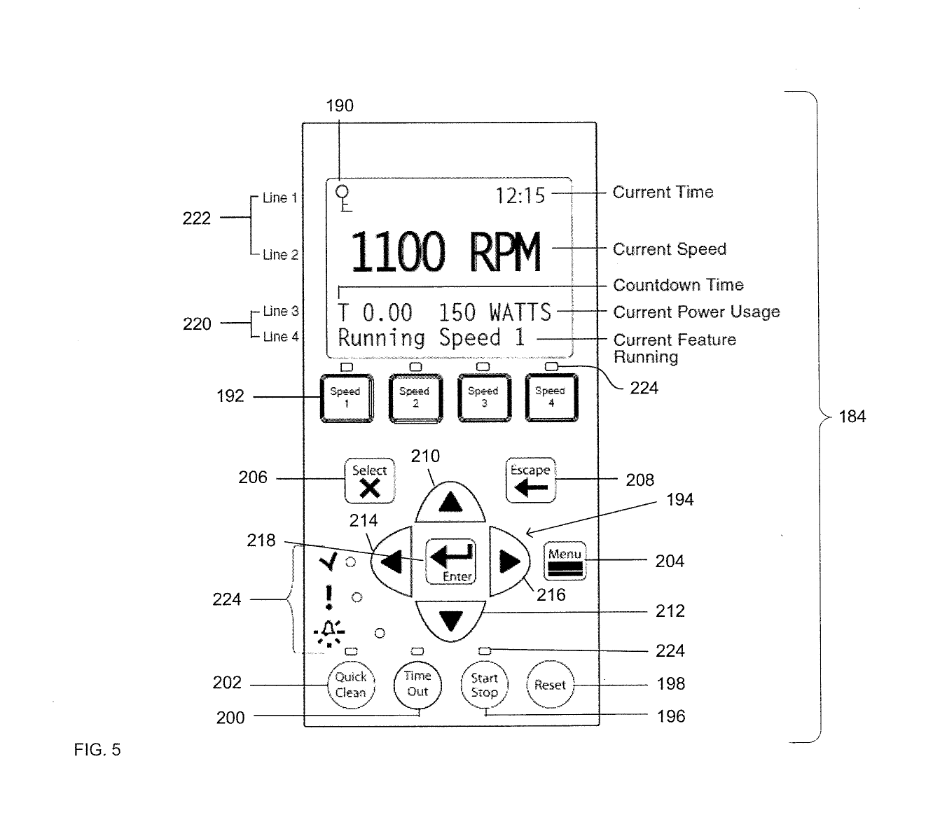

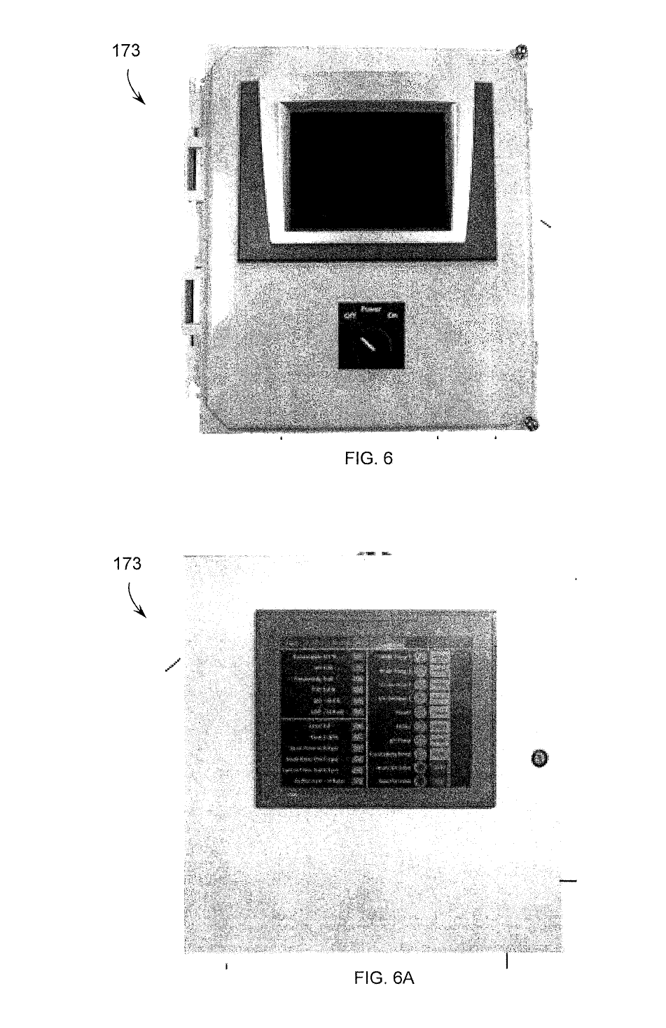

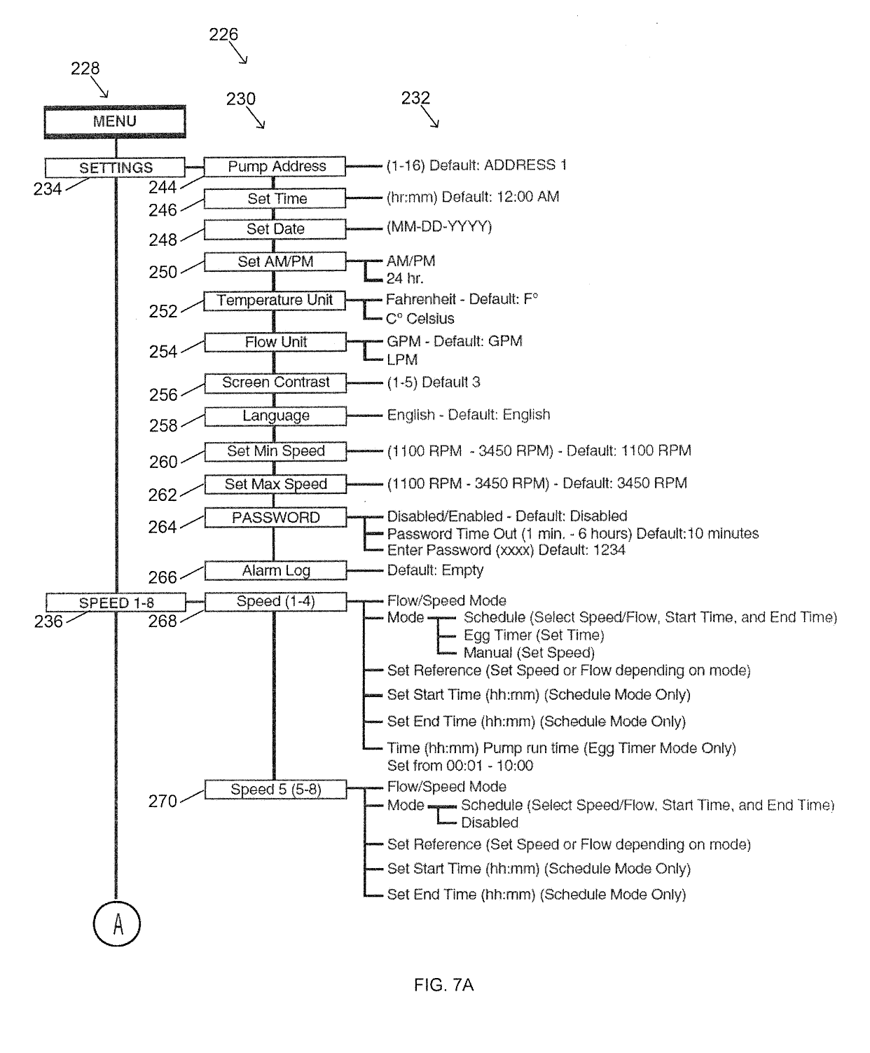

In some embodiments, an optional RFID module may be interconnected with the processor via a second communication link, and/or an optional “WI-FI” module interconnected with the processor via a third communication link. In other embodiments, the controller 128 can includes connections as shown in FIG. 4. In particular, the controller 128 can include an input power line 172 to receive power (e.g., from a mains line), a JTAG connection 174 for, for example, basic firmware (or microcode) loading in the factory and/or in the field. The controller 128 can include a 2-lead RS485 connection 176 for, for example, connection with an external service device for firmware updating in the field and/or connection to an external controller or automation system 173 (as shown in FIG. 6 and further described below). Aquaculture application components, such as the controller 106, one or more control valves 118 and/or one or more sensors 120, and/or a remote user interface 178, may be connected to the controller 128 via connections 180 and 182, respectively, through the external controller 173, as shown in FIG. 4. Alternatively, the aquaculture application components and/or the remote user interface 178 may be connected directly to the controller 128. An on-board user interface 184 (as shown in FIG. 5 and further described below) can be connected to the controller 128 via a 5-lead RS485 connection 186. Finally, the controller 128 can include an output power line 188 for providing power and/or control signals to the variable speed motor 104 (via the coupling 164 shown in FIG. 3).

FIG. 5 illustrates the user interface 184 for the controller 128, according to one embodiment. The user interface 184 is provided to allow a user to control one or more components, parameters, and/or methods associated with the aquaculture system 100. The user interface 184 may include a display 190, at least one speed/flow button 192, one or more navigation buttons 194, a start-stop button 196, a reset button 198, a manual override button 200, and a “quick clean” button 202. The manual override button 200 may also be called a “time out” button. In some embodiments, the navigation buttons 194 may include a menu button 204, a select button 206, an escape button 208, an up-arrow button 210, a down-arrow button 212, a left-arrow button 214, a right-arrow button 216, and an enter button 218. The navigation buttons 194 and the speed/flow buttons 192 may be used to program a user-defined flow rate or schedule into the controller 128.

In some embodiments, the display 190 may include a lower section 220 to display information about a parameter and an upper section 222 to display a value associated with that parameter. In other embodiments, the display 190 can include one, two, three, four, or more display lines to show different values, parameters, and/or other information. For example, as shown in FIG. 5, a first line can display information about password protection, operation mode, navigation symbols, and/or clock time. A second line can display a present value (e.g., a present flow rate). A third line can display additional information about this present value (e.g., countdown time, present power usage). A fourth line can display a state of the controller 128 (e.g., stopped or running a particular speed/flow setting). In addition, in some embodiments, the user interface 184 may include one or more light emitting diodes (LEDs) 224 to indicate normal operation and/or a detected error or warning of the variable speed pump 104, and/or other operational components of the aquaculture system 100.

Referring back to FIG. 2, the user interface 184 can be mounted on the case 166. In some embodiments, the user interface 184 can be removable from the case 166 so that it can be removed, rotated 90, 180, or 270 degrees, and then re-mounted on the case 166. In addition, in some embodiments, the user interface 184 can be removed from the case 166 and mounted remotely, for example, on a wall (not shown) remote from the variable speed pump 104 but easily accessible to a user. A length of connection cable (not shown) can connect the user interface 184 to the controller 128. The connection cable can allow the user interface 184 to be moved away from, yet still connected to, the controller 128 in order operate the user interface 184 remotely from the controller 128 and the case 166. However, when the user interface 184 is mounted on the case 166, the connection cable can be stored inside the case 166.

Referring now to FIG. 6, the external controller 173, or automation system, for the variable speed pump 104 is depicted. The external controller 173 may communicate with the controllers 106 and 128. The external controller 173 may control the variable speed pump 104, and/or other components of the aquaculture system 100, in substantially the same way as described for the controllers 106 and 128. The external controller 173 may be used to operate the variable speed pump 104 and/or program the controllers 106 and 128, if the variable speed pump 104 is installed in a location where the user interface 184 is not conveniently accessible. The external controller 173 may include one or more of the buttons described herein and may be used to control one or more components, parameters, and/or methods associated with the aquaculture system 100, either as a standalone controller, or in conjunction with the on-board controller 128.

In one embodiment, the external controller 173 (or the other controllers 128, 106) can operate or program flow rates based on input from other components of the aquaculture system. For example, based on sensor readings or determinations of dissolved oxygen, carbon dioxide, nitrite, ammonia, water levels, or other parameters, the external controller 173 can automatically set or adjust a manual, countdown, or scheduled flow rate of the variable speed pump 104 in order to maintain optimal water conditions for the housed aquatic life. In another embodiment, the external controller 173 may be interfaced with the drive controller (e.g., controller 106, 128) to read system sensor data and adjust the performance of the variable speed pump 104.

The component parts having been described, operation of the variable speed pump 104 will now be discussed. Generally, water may be recirculated through the aquaculture system 100 using the variable speed pump 104, (i.e., through the fluid circuit) to ensure optimal aquatic life conditions within the culture tank 102. More particularly, the controllers 106 and/or 128 (and/or 173) of the variable speed pump 104 may monitor one or more parameters of the system 100 and may automatically execute necessary actions (e.g., adjusting water flow rates, air flow rates, the control valves 118, etc.) to maintain optimal aquatic life conditions within the culture tank 102. Furthermore, the controllers 106 and/or 128 may execute one or more actions to reduce energy consumption of the system 100. More specifically, substantial costs of maintaining aquaculture systems generally include feed costs, electricity costs, oxygen costs, and combinations thereof. The controllers 106 and/or 128, either as a separate component from the variable speed pump 104 (i.e., the controller 106), or integrated into the variable speed pump 104 (i.e., the controller 128), may control components of the system 100 (e.g., the variable speed pump 104, the blower 116, the control valves 118, combinations thereof, etc.) to maintain optimal aquatic life conditions in addition to minimizing electricity and oxygen costs.

For example, the controllers 106 and/or 128 may control the variable speed pump 104 to operate at a low speed to maintain a minimum water flow rate necessary to achieve optimal aquatic life conditions and may also increase the speed and, thus, water flow rate only when necessary (such as to increase dissolved oxygen levels during feeding). Accordingly, the variable speed pump 104 may be operated by the controllers 106 and/or 128 according to a flow control algorithm, as further described below. As a result, in contrast to conventional systems with single-speed pumps that constantly run at a high speed, the variable speed pump 104 and the controllers 106 and/or 128 of the aquaculture system 100 may greatly minimize electricity and power consumption of the system 100. Furthermore, automatic execution of necessary actions to variably adjust water flow may minimize electricity and power consumption in comparison to conventional systems. Moreover, the aquaculture system 100, including automatic control by the controllers 106 and/or 128, allows for rapid and efficient maintenance following startup since the typical learning curve of manual system operators is removed. For example, in manual systems, operators must learn to monitor system conditions and then step up or step down flow rates by manually adjusting different control valves.

Generally, in some embodiments, the controller 128 may automatically operate the variable speed pump 104 according to at least one schedule (e.g., an on-peak schedule, an off-peak schedule, a feeding schedule, an aquatic life rest schedule, etc.). A schedule can include a designated speed or flow rate through the variable speed pump 104 as well as a scheduled start time, a scheduled stop time, and/or a duration. In additional embodiments, the controller 128 may allow a manual operation of the variable speed pump 104. In other embodiments, the controller 128 may monitor the operation of the variable speed pump 104 and may indicate abnormal conditions of the variable speed pump 104 (i.e., through audible or visual alarms). In yet other embodiments, the controller 128 can include a manual override (e.g., through the manual override or “time out” button 200). The manual override can interrupt the scheduled and/or manual operation of the variable speed pump 104 to allow for cleaning and maintenance procedures of the aquaculture system 100, for example.

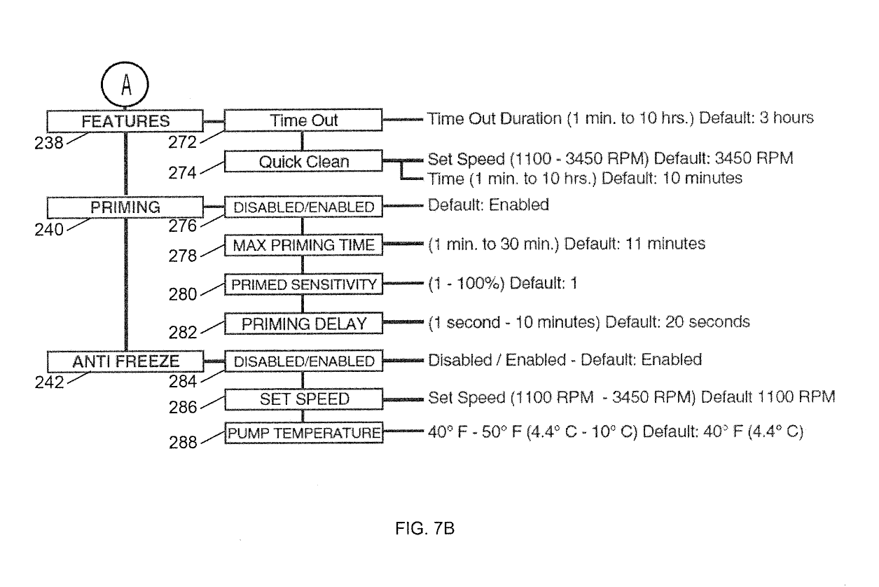

More specifically, FIGS. 7A-7B illustrate a menu 226 for the controller 128 according to one embodiment. In some embodiments, the menu 226 can be used to program various features of the controller 128. For example, the menu 226 can include a hierarchy of categories 228, parameters 230, and values 232, any one of which can be displayed by the display 190 of the user interface 184 so that an operator, user or installer can program the various features on the controller 128. For example, from the display 190, a user can enter the menu 226 by pressing the menu button 204. The user can scroll through the categories 228 (i.e., so that the display visually scrolls through the menu 226) using the up-arrow button 210 and the down-arrow button 212. In some embodiments, a user can also access the menu via a “back door” operation through the external controller 173 or another device connected through the JTAG connection 174 or the 2-lead RS485 connection 176 (as shown in FIG. 4). The back door operation may also allow a user to access parameters not part of the menu (e.g., for servicing the controller 128).

As shown in FIGS. 7A-7B, the categories 228 can include settings 234, speed/flow 236, features 238, priming 240, and anti freeze 242 (in any order). In some embodiments, the user can enter a category 228 by pressing the select button 206. The user can scroll through the parameters 230 within a specific category 228 using the up-arrow button 210 and the down-arrow button 212. The user can select a parameter 230 by pressing the select button 206 and can adjust the value 232 of the parameter 230 with the up-arrow button 210 and/or the down-arrow button 212. In some embodiments, the value 232 can be adjusted by a specific increment or the user can select from a list of options. If the value 232 includes more than one digit, the user can adjust a first digit with the up-arrow button 210 and/or the down-arrow button 212, and then move to the next digit with the left-arrow button 214 or the right-arrow button 216. The user can save the value 232 by pressing the enter button 218. By pressing the escape button 208, the user can exit the menu 226. If the user does not press the enter button 218 before pressing the escape button 208, any changes may not be saved.

In some embodiments, the settings category 234 can include a pump address setting 244, a time setting 246, a date setting 248, an AM/PM setting 250, a temperature unit setting 252, a flow unit setting 254, a screen contrast setting 256, a language setting 258, a minimum speed setting 260, a maximum speed setting 262, a password setting 264, an alarm log setting 266, and/or other settings parameters. The pump address setting 244 can include pump address values 1-16, and default at address number 1. The pump address setting can allow an external automation system, such as the external controller 173, to identify the variable speed pump 104. The time, date, and AM/PM settings 246, 248, 250 can be used to set a system clock in order for the controller 128 to operate the pump 104 according to scheduled start and stop times, functions, or other programmed cycles. The temperature unit and flow unit settings 252, 254 can be set with desired units to display (e.g., Fahrenheit or Celsius for temperature, gallons per minute (GPM) or liters per minute (LPM) for flow). The screen contrast setting 256 can allow a user to select one of, for example, 5 levels of screen contrast, or brightness, for using the variable speed pump 104 in low or high lighting conditions.

The password setting 264 can allow a user to enable and set a password (such as a four-digit, numerical password) for accessing or adjusting options on the user interface 184. When the password setting 264 is enabled, the display 190 will prompt the user for the password before allowing access to the user interface buttons. In one embodiment, without entering the password, a user may only be able to use the start/stop button 196 and the reset button 198. In addition, the language setting 258 can allow a user to set a desired language for text shown on the display 190.

The alarm log setting 266 can allow a user to access and review previous pump alerts, warnings, or alarms (“fault conditions”) saved in the alarm log. Example fault conditions can include one or more of power out failure, priming error, overheat alert, anti-freezing, over-current, over-voltage, internal power supply fault, invalid motor, invalid pump, controller fault, among others. When any of these fault conditions occur, the controller 128 can stop the motor 126 for a predetermined rest period (such as 20 seconds, 10 minutes, etc.) and then attempt to clear the fault condition. Some fault conditions can permit infinite resets, while others may only allow a pre-set number of resets before the pump 104 must be manually restarted. In addition, if one or more fault conditions occur at the same time, respective actions can be taken for the highest priority fault condition.

The power out failure can occur when incoming supply voltage drops below a preset value, such as 170 volts AC. When this condition occurs, the controller 128 can fault to protect itself from over current, but can stay powered up long enough to save current operation parameters. The priming error fault can occur when the pump 104 is not primed within the set maximum priming time (as further discussed below). When this occurs, the pump 104 can stop for 10 minutes and then attempt to prime again. The pump 104 can attempt to prime about five times before requiring a manual reset. The overheat alert can occur when the controller temperature reaches a preset maximum temperature, such as over about 54 degrees Celsius. When this occurs, the controller 120 can slowly reduce pump speed until the overheat condition clears. The anti-freezing fault can occur when the controller temperatures reaches a set minimum temperature (as further described below). When this occurs, and anti-freeze protection is enabled and the controller 128 can operate the pump at a preset speed until the temperature increases above the minimum. The over-current fault can occur when the controller drive is overloaded or the motor 126 has an electrical problem. The controller 128 can stop the motor 126 and then restart the drive about 20 seconds after the over-current condition clears. The over-voltage fault can occur when excessive voltage is experienced by the controller 128 (either from the supply side or from the motor side). The controller 128 can stop the motor 126 and then restart the drive about 20 seconds after the over-current condition clears.

When one of the above (or other) fault conditions occur, a respective LED 224 will by lit on the user interface and the specific fault condition will be displayed on the display 190. All other user interface buttons can be disabled until the alarm or warning is acknowledged by a user pressing the enter button 218. The fault condition can be cleared (though still saved in the alarm log) by the user pressing the reset button 198. In some embodiments, one or more of the above-described maximum or minimum pre-sets related to the fault conditions may be non-adjustable features. In addition, the controller 128 can perform automatic operations outside of the described menu operations, such as identifying the connected motor and/or pump.

The minimum speed setting 260 and the maximum speed setting 262 can be adjusted according to the volume or type of the aquaculture application. For example, an installer of the variable speed pump 104 can provide the minimum speed setting 260 and the maximum speed setting 262 upon installation of the variable speed pump 104. The controller 128 can automatically prevent the minimum speed setting 260 from being higher than the maximum speed setting 262. The minimum and maximum speed settings 260, 262 can be set so that the variable speed pump 104 will not operate outside of these speeds in order to protect flow-dependent devices with specified minimum speeds and pressure-sensitive devices (e.g., filters) with specified maximum speeds. In one embodiment, the speed selection range can be from about 1100 RPM to about 3450 RPM, the default minimum speed can be set at about 1100 RPM, and the default maximum speed can be set at about 3450 RPM.

In some embodiments, the speed/flow category 236 can be used to input data for running/operating the variable speed pump 104 manually and/or automatically (i.e., via programmed speed or flow settings). In some embodiments, the pump controller 128 can store a number of pre-set speed or flow settings (such as eight). In this example, each of the first four speed/flow settings in a first set of speeds/flows 268 (“Speed 1-4”) can first be selected as flows or speeds. Following this selection, a user can set a reference speed or flow rate, and then select values for a manual, scheduled (e.g., with set start and stop times), or countdown/timer (e.g., with a time duration) mode. In one embodiment, Speeds 1-4 can include default reference flows of 40 GPM, 50 GPM, 60 GPM, and 70 GPM, respectively. Similarly, each of the second four speed/flow settings in a second set of speeds/flows 270 (“Speed 5-8”) can be programmed in speed or flow mode, and in a manual, scheduled, or countdown mode. In one embodiment, Speeds 5-8 can only be set in schedule mode (and not manual or countdown mode). In addition, not all of speeds 5-8 in the second set of speeds/flows 270 must be programmed to run on a schedule. For example, one or more of speeds 5-8 can be disabled. In one embodiment, the default setting for speeds 5-8 is “disabled.”

In some embodiments, the speed/flow settings from both sets 268, 270 can be programmed into the controller 128 using the up-arrow button 210, the down-arrow button 212, and the enter button 218 to select the above-described values. Generally, each speed/flow setting can include a speed, a start time, a stop time, and/or duration depending on the respective mode. For example, for the manual mode, a reference speed/flow can be programmed. To then operate in manual mode, a user can press a desired speed/flow button 192 and then press the start/stop button 196. The controller 128 will then run the assigned flow for that speed/flow button 192. In addition, a user can manually adjust a present flow while the variable speed pump 104 is operating by pressing the up-arrow button 210 or down-arrow button 212. The user can program the new flow under the previous flow setting selection (such as Speed 1) by pressing the enter button 218. Alternatively, the user can program the new flow under any one of Speeds 1-4 by pressing and holding a respective speed/flow button 192 for approximately three seconds. For the countdown timer mode, a reference speed/flow and duration can be programmed. To operate in the countdown timer mode, a user can press a desired speed/flow button 192 and then press the start/stop button 196. The controller 128 will then run the assigned flow for that speed/flow button 192 for the programmed duration of time after the speed/flow button 192 has been pressed, and then stop the variable speed pump 104 (e.g., until the next programmed schedule time or the user manually selects a flow rate or speed). In addition, in some embodiments, the speed/flow settings from both sets 268, 270 can be programmed into the controller 128 via the external controller 173.

For the scheduled mode, a reference speed/flow, a start time, and a stop time can be programmed. These programmed flow schedules can start and stop at a specific time during a 24-hour period. The display 190 can show “Running Schedules” when the controller 128 is ready to run a scheduled flow. After the user presses the start/stop button 196, the controller 128 can then operate according to the current schedule and the display 190 can show “Running Speed [1-8]” according to the current scheduled flow. If two or more schedules are programmed into the controller 128 for the same time, the schedule with the highest priority level over the remaining schedules can be run. For example in one embodiment, the following priority list (highest priority to lowest priority) can be used: highest flow, lowest flow, highest speed, lowest speed, idle (i.e., 0 RPM). In another embodiment, if the variable speed pump 104 is manually operated and is overlapping a scheduled run, the scheduled run can have priority over the manual operation independent of the present speed/flow of the variable speed pump 104. In yet another embodiment, the most recent command, manual or schedule, will take priority. When running a schedule or countdown mode, the display 190 can show a remaining time for that mode. The display 190 can also show the present operating speed (e.g., “1100 RPM”). In addition, when running one of Speeds 1-4, the LED 224 over the respective speed/flow button 192 can be lit.

When the speed/flow settings are set to “flow mode” with reference flow rates, the controller 128 can operate to maintain that flow rate within the fluid circuit. For example, a user can set different flow rates (e.g., for Speeds 1-4) relating to certain periods in the life cycle of the housed aquatic life within the culture tank 102. Thus, when the aquatic life reaches that period in the life cycle, the user can change the desired flow rate by selecting the appropriate speed/flow button 192. In another example, a user can set schedules of flow rates (e.g., for Speeds 5-8) relating to certain daily or weekly periods, such as an on-peak schedule, an off-peak schedule, a feeding schedule, an aquatic life rest schedule, etc. For example, due to increased activity and oxygen consumption during feeding, a higher flow rate may be set during a feeding schedule, while and a lower flow rate may be set during a rest schedule when less oxygen consumption occurs. The schedules can then automatically run according to the times set by the user.

Referring to FIG. 7B, the features category 238 can be used to program a manual override. In some embodiments, the parameters of the features category 238 can include a “time out” program 272 and a “quick clean” program 274. The “time out” program 272 can interrupt the operation of the variable speed pump 104 and/or the variable speed motor 126 for a certain amount of time, which can be programmed into the pump controller 128. The “time out” program 272 can be selected by pressing the “time out” button 200 on the user interface 184. In one example, the “time out” program 272 can be used to stop operation of the variable speed pump 104 so that a user can perform maintenance procedures on one or more components of the aquaculture system 100. The respective LED 224 adjacent to the “time out” button 200 can be lit when the “time out” program 272 is active.

The “quick clean” program 274 can include a speed setting and a duration setting. The “quick clean” program 274 can be selected by pressing the “quick clean” button 202 located on the user interface 184. When pressed, the “quick clean” program 274 can have priority over the scheduled and/or manual operation of the variable speed pump 104. The respective LED 224 adjacent to the “quick clean” button 202 can be lit when the “quick clean” program 274 is active. After the variable speed pump 104 has been operated for the time period programmed into the duration setting, the variable speed pump 104 can resume back to a scheduled, countdown, or manual operation.

In the priming category 240, the priming of the variable speed pump 104 can be enabled or disabled at setting 276. The priming sequence of the variable speed pump 104 can remove substantially all air in the variable speed pump 104 in order to allow water to flow through the variable speed pump 104 and/or the fluid circuit. If priming is enabled, a maximum duration for the priming sequence (“max priming time”) can be programmed into the pump controller 128 at setting 278. This is the maximum duration, for example, between about 1 minute and about 30 minutes that the variable speed pump 104 will try to prime before giving an error. In some embodiments, the priming sequence can be run/driven at the maximum speed 262. In another example, the variable speed pump 104 can be run at a first speed (e.g., 1800 RPM) for a first duration (e.g., about three seconds). If there is sufficient flow through the variable speed pump 104, priming is completed. If not, the variable speed pump 104 can be run at the maximum speed 262 for a priming delay time (such as about 20 seconds, set at setting 282). If there is sufficient flow through the variable speed pump 104 at this point, priming is completed. If not, the variable speed pump 104 can continue to be run at the maximum speed 262 for an amount of time set by the maximum priming time setting 278. If there is still not sufficient flow when the maximum priming time setting 278 has expired, a dry priming alarm can be reported (e.g., via the LEDs 224 and/or the display 190) and saved in the alarm log 266. In addition, a priming sensitivity value from 1% to 100% can be selected at setting 280. This priming sensitivity value affects the determination of whether flow is sufficient to consider priming completed. Lower sensitivity values increase the amount of flow needed for the variable speed pump 104 to sense that it is primed, while higher sensitivity values decrease the amount of flow needed for the variable speed pump 104 to sense that it is primed.

In some embodiments, an internal temperature sensor of the variable speed pump 104 can be connected to the controller 128 in order to provide an anti freeze operation (also considered a “thermal mode” operation) for the aquaculture system 100 and the variable speed pump 104. In the anti freeze category 242, an enable/disable setting 284 can be set to enable or disable the anti freeze operation. Furthermore, a speed setting 286 and a temperature setting 288 at which the variable speed pump 104 can be activated to prevent water from freezing in the aquaculture system 100 can be programmed into the pump controller 128. If the temperature sensor detects a temperature lower than the temperature setting 288, the variable speed pump 104 can be operated according to the speed setting 286. In some embodiments, the internal temperature sensor can sense a temperature of the variable speed motor 126 and/or the variable speed drive of the controller 128. For example, the internal temperature sensor can be embedded within a heat sink positioned between the controller/variable speed drive and the variable speed motor 126.

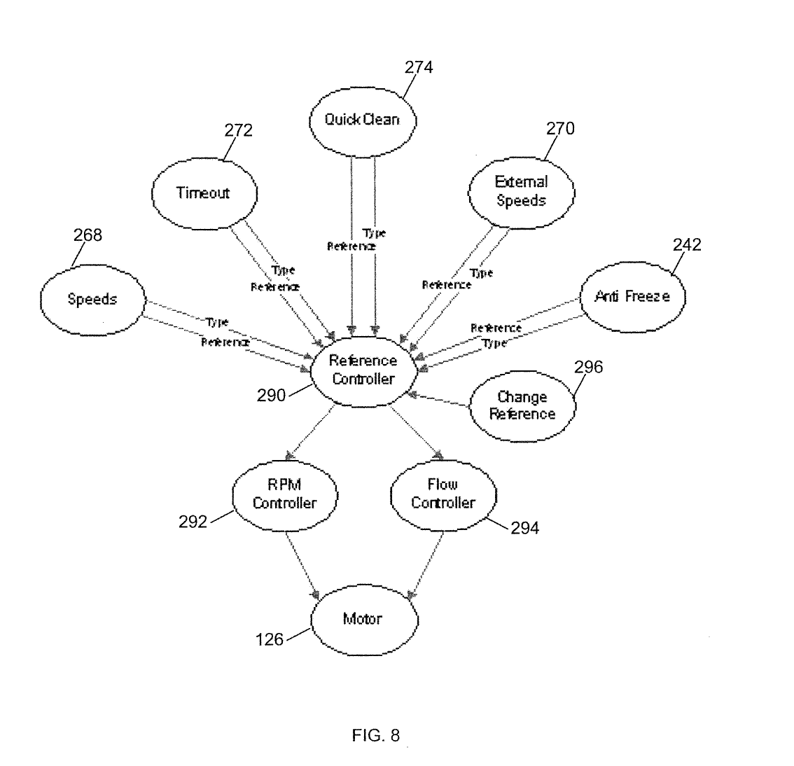

In accordance with the above menu operations, FIG. 8 illustrates a command path of the controller 128, according to one embodiment. As shown in FIG. 8, the controller 128 can include a reference controller portion 290, a speed controller portion 292, and a flow controller portion 294. User-set values 232 (e.g., a reference value and a reference type (RPM or GPM)) from different menu categories 228 or parameters 230 can be input to the reference controller 290. In addition, in some embodiments, the features category 238 can include a “change reference” option 296, which allows a user to change the reference “on the fly.” For example, if the controller 128 is currently maintaining a user-defined speed, and the change reference option 296 is selected, the controller 128 can then maintain the present flow rate at that user-defined speed. Alternately, if the controller 128 is currently maintaining a user-defined flow rate, and the change reference option 296 is selected, the controller 128 can then maintain the present speed at that user-defined flow rate. The new flow rate or speed, respectively, can also be saved under the previously set selection (i.e., one of Speeds 1-8).

Based on the selected reference type (i.e., flow rates or speeds), the reference controller 290 communicates with the speed controller 292 or the flow controller 294. The speed controller 292 or flow controller 294 then output control signals for operating the motor 126. In particular, the speed controller 292 can maintain a user-defined speed (±about 4 RPM) and the flow controller 294 can run the motor 126 at a minimum speed necessary to maintain a user-defined flow rate (−about 0 GPM, +about 10 GPM). The reference controller 290 can also ensure that speeds output by the speed controller 292 or the flow controller 294 do not exceed the pre-set minimum or maximum speeds.

The controller 128 and, in particular, the flow controller 294, can continuously or periodically adjust the speed of the variable speed motor 126 in order to maintain the set flow rate. Speed adjustments may be required because of increasing pressure build-up in the fluid circuit, caused by changing conditions in the aquaculture system 100. This pressure build-up can require an increasing pressure and, more specifically, increasing force from the variable speed motor 126 to maintain a constant flow rate within the fluid circuit. The ability to maintain a constant flow rate is useful to achieve optimal conditions for the housed aquatic life. Further, maintaining a minimum required flow rate at all times can reduce energy and operating costs of the variable speed pump 104. In particular, an increase in flow resistance, or pressure build-up, within the fluid circuit would cause a conventional single-speed pump, operating at a constant maximum speed, to lose flow, enough so that optimal water conditions are not achieved as a result of the loss of flow. Suboptimal conditions can hinder aquatic life growth and/or kill the aquatic life. While these conventional systems may have valves that can be opened or closed to manually adjust flow rates, such adjustments are crude and cannot help optimize energy usage by the single-speed pump.

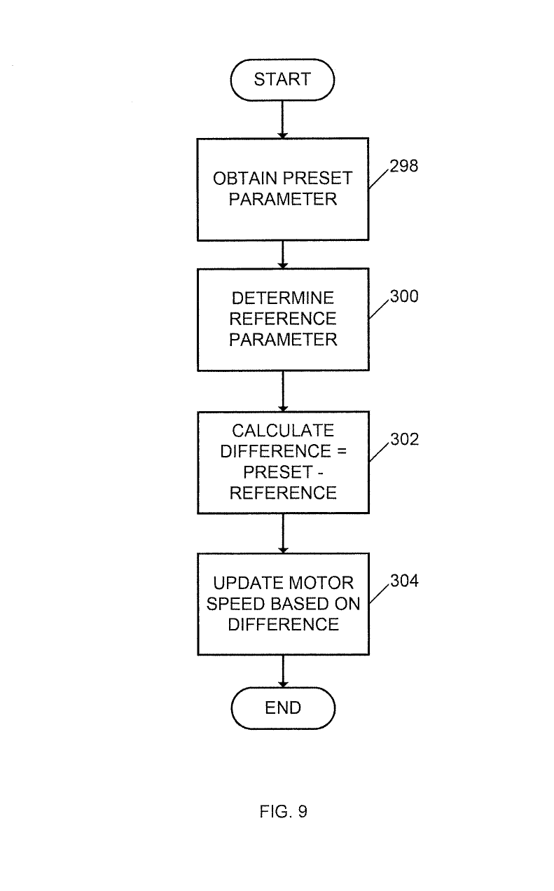

Generally, the controller 128 and/or flow controller 294 can operate according to the method illustrated in FIG. 9, in order to operate the variable speed pump 104 at a constant, user-defined flow rate. First, the controller 128 can obtain a present parameter, either sensed or otherwise determined in the aquaculture system 100 (step 298). The controller 128 can then determine or calculate a reference parameter related to a user-defined flow rate (step 300). The controller 128 then determines the difference between the present parameter and the reference parameter (step 302). Based on this difference, the controller 128 determines a new speed required to reach the user-defined flow rate (step 304).

More specifically, in some embodiments, the controller 128 can determine flow rates based on power consumption of the motor 126 and/or the speed of the motor 126. For example, the controller 128 can determine (e.g., receive, obtain, or calculate) a current speed of the variable speed motor 126, determine a reference power consumption based on the current speed of the variable speed motor 126 and the programmed flow rate, and determine (e.g., receive, obtain, or calculate) the current power consumption of the variable speed motor 126. The pump controller 128 can then calculate a difference value between the reference power consumption and the current power consumption and use proportional (P), integral (I), derivative (D) control, and/or some combination thereof (e.g., P, I, PI, PD, PID) based on the difference value to generate a new speed of the variable speed motor 126 that will achieve the programmed flow rate. The controller 128 can then adjust the current speed of the variable speed motor 126 to the new speed to maintain the programmed flow rate.

Alternatively, the pump controller 128 can determine (e.g., receive, obtain, or calculate) a current speed of the variable speed motor 126, the current power consumption of the variable speed motor 126, and the current flow rate through the aquaculture system 100 (i.e., based on the current power consumption and/or the current speed). The pump controller 128 can then calculate a difference value between the reference power consumption and the current power consumption and use proportional, integral, derivative control and/or some combination thereof based on the difference value to generate a new speed of the variable speed motor 126 that will achieve the programmed flow rate. The pump controller 128 can then adjust the current speed of the variable speed motor 126 to the new speed to maintain the programmed flow rate.

In light of the above, embodiments of the present disclosure provide a constant flow variable speed pump for an aquaculture system. The variable speed pump can operate at a minimum speed to maintain proper flow rates to ensure optimal conditions for aquatic life in the aquaculture system. The flow rates can be adjusted according to set schedules to account for specific types of aquatic life, feeding schedules and/or rest schedules of the aquatic life, growth cycles of the aquatic life, and dynamic changes to conditions within the aquaculture system. The variable speed pump can ensure continuous and substantial growth of the aquatic life, as well as reduce energy and operating costs of the aquaculture system, compared to conventional systems, by using the most energy-efficient speed to deliver a constant flow rate. Further, by automatically adjusting flow rates, the variable speed pump removes the need for a user to manually adjust valves in the aquaculture system. This reduces the learning curve for start-up systems. In addition, one or more controllers of the variable speed pump can include databases of reference flow rates (e.g., related to aquatic life type, feeding and sleep schedules, and/or growth cycles) to aid users in setting correct flow rates through the system, again reducing the learning curve for start-up systems.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. A recirculating aquaculture system for housing aquatic life, the system comprising:
a culture tank;
a fluid circuit including the culture tank, a drain line exiting the culture tank, and a return line entering the culture tank;
at least one of a biofilter, an oxygen cone, a regenerative air blower, a degassing column in communication with the fluid circuit; and
a variable speed pump in communication with the fluid circuit and configured to pump water through the fluid circuit into and out of the culture tank, the variable speed pump including:
a motor, and
a controller configured to operate the motor to maintain a constant flow rate through the fluid circuit despite pressure and water condition changes within the fluid circuit.

2. The system of claim 1, wherein the constant flow rate is a user-defined flow rate.

3. The system of claim 1, wherein the controller is configured to operate the motor to maintain a first constant flow rate for a first time period according to first user-defined schedule, and operate the motor to maintain a second constant flow rate for a second time period according to a second user-defined schedule.

4. The system of claim 3, wherein the first user-defined schedule is an aquatic life feeding schedule and the second user-defined schedule is an aquatic life resting schedule.

5. The system of claim 1, wherein the variable speed pump further includes a user interface configured to receive user input including a user-defined flow rate and user-defined schedules.

6. The system of claim 1 further comprising at least one sensor in communication with the fluid circuit and the variable speed pump.

7. The system of claim 6, wherein the controller is configured to operate the motor to maintain a new constant flow rate through the fluid circuit based on input from the at least one sensor.

8. The system of claim 6, wherein the at least one sensor includes one of a water quality probe, a water flow rate sensor, an oxygen gas flow rate and pressure sensor, and a water pressure sensor.

9. The system of claim 1, wherein a portion of the fluid circuit is formed by plumbing.

10. A constant flow variable speed pump for use in a recirculating aquaculture application, the pump comprising:
a housing including an inlet and an outlet;
a motor in communication with the housing, the motor causing water flow through the recirculating aquaculture application; and
a controller in communication with the motor and configured to drive the motor, the controller configured to adjust a speed of the motor to maintain a first flow rate through the recirculating aquaculture application between a first start time and a first stop time according to a first user-defined schedule, and to maintain a second flow rate through the recirculating aquaculture application between a second start time and a second stop time according to a second user-defined schedule.

11. The pump of claim 10, wherein the first user-defined schedule is an aquatic life feeding schedule and the second user-defined schedule is an aquatic life resting schedule.

12. The pump of claim 10 further comprising a user interface in communication with the controller and configured to receive user input regarding parameters of the first user-defined schedule and the second user-defined schedule.

13. The pump of claim 12, wherein the controller is further configured to adjust a speed of the motor to maintain a third flow rate through the recirculating aquaculture application based on user input through the user interface.

14. The pump of claim 10, wherein the controller includes a variable speed drive.

15. The pump of claim 10, wherein the controller adjusts the speed of the motor to maintain one of the first flow rate and the second flow rate based on one of a sensed power consumption of the motor and a sensed flow rate within the recirculating aquaculture application.

16. A method of operating a variable speed pump in an aquaculture system, the method comprising:
obtaining at least one of a current speed parameter or a power consumption parameter of the aquaculture system;
determining a reference parameter based on a user-defined flow rate through the aquaculture system;
calculating a difference value between the current speed parameter or the power consumption parameter obtained and the reference parameter;
updating a pump motor speed based on the difference value; and
driving a motor of the variable speed pump at the updated pump motor speed to maintain the user-defined flow rate.

17. The method of claim 16 further comprising updating the pump motor speed using one of proportional, integral, and derivative control based on the difference value.

18. The method of claim 16 further comprising periodically repeating the steps of obtaining, determining, calculating, updating, and driving the motor to maintain the user-defined flow rate despite changes to conditions within the aquaculture system.

19. The method of claim 16 further comprising measuring a parameter within the aquaculture system using a sensor.

20. The method of claim 19 further comprising adjusting the pump motor speed automatically based on a measurement provided by the sensor.
